(19) United States
(12) Patent Application Publication
(10) Pub. No.: US 2007/0206230 A1
(43) Pub. Date: Sep. 6, 2007

(54) Image processor

(75) Inventors: Ken Nishio, Osaka (JP); Toshiyuki Nakade, Osaka (JP); Seiji Onishi, Osaka (JP); Keisaku Matsumae, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/712,399

(22) Filed: Mar. 1, 2007

(30) Foreign Application Priority Data
Mar. 1, 2006 (JP) 2006-055139

(51) Int. Cl. H04N 1/23

(52) U.S. Cl. 358/296

(57) ABSTRACT

An image processor has an image scanning unit, a memory, an address specification unit, a scan control unit, and a transmission control unit. The image scanning unit is configured to scan an original image. The memory is configured to store image data scanned by the image scanning unit. The address specification unit is able to specify a plurality of addresses of different protocols as multi-address destination. The scan control unit controls the image data scanned by the image scanning unit. The transmission control unit is configured to generate an image data from an image data stored in the memory, such that the image data has an image quality that is appropriate for the protocol corresponding to each of the addresses specified by the address specification unit, and transmit the image data to each of the addresses.

### CROSS-REFERENCE TO RELATED APPLICATIONS

This application claims priority to Japanese Patent Application No. 2006-055139 filed on Mar. 1, 2006. The entire disclosure of Japanese Patent Application No. 2006-055139 is hereby incorporated herein by reference.

### BACKGROUND OF THE INVENTION

1. Field of the Invention

The present invention generally relates to an image processor. More specifically, the present invention relates to an image processor, such as a multifunction device having a copying function, a facsimile function, and the like, or a facsimile device, or the like.

2. Background Information

As seen in Japanese Patent Application Publication 2001-345987, an image processor has been proposed that is able to transmit using a plurality of protocols (FAX, InternetFAX, SMB, and the like). The image processor sequentially performs transmission to addresses having a plurality of protocols after an original document has been scanned in the case that addresses having a plurality of protocols are specified. This image processor has an address specification means that is able to specify an address within a plurality of protocols.

In addition, as seen in Japanese Patent Application Publication 2000-295387, another image processor has been proposed that is able to print and to transmit facsimile simultaneously.

Meanwhile, since an image that is transmitted via SMB (Server Message Block), FTP (File Transfer Protocol), and the like and saved in a PC is for the purpose of reusing the image, it is demanded that the image quality thereof be as close to the image quality of the original image as possible. Further, when transmitting an image via facsimile, a telephone line is used. Thus, a processed image quality that allows for as short a connection time as possible is desired.

Conventionally, when transmitting a scanned image simultaneously via both the protocols of SMB and FAX, the image is transmitted using an image quality that is suitable for transmitting the image via one of either of the protocols. When transmitting an image with a high image quality suitable for transmission via SMB, via both of the protocols of SMB and FAX, the connecting time becomes longer in a facsimile transmission. When transmitting an image, with a low image quality suitable for transmission via FAX via both of the protocols of SMB and FAX, it becomes difficult to use the saved duplicate of the original in a SMB transmission for the intended purpose thereof.

In view of the above, it will be apparent to those skilled in the art from this disclosure that there exists a need for an improved an image processor. This invention addresses this need in the art as well as other needs, which will become apparent to those skilled in the art from this disclosure.

### SUMMARY OF THE INVENTION

An object of the present invention is to provide an image processor that will be able to transmit an image with an image quality appropriate for protocols when transmitting the image simultaneously to addresses having a plurality of protocols.

An image processor according to a first aspect of the present invention has an image scanning unit, a memory, an address specification unit, a scan control unit, and a transmission control unit. The image scanning unit is configured to scan an original image. The memory is configured to store image data scanned by the image scanning unit. The address specification unit is able to specify a plurality of addresses of different protocols as a multi-address destination. The scan control unit controls the image data scanned by the image scanning unit to be saved in the memory, when a transmission start command is inputted after an address is specified by the address specification unit, and an original image is scanned by the image scanning unit. The transmission control unit is configured to generate an image data from an image data stored in the memory such that the image data have an image quality that is appropriate for the protocol corresponding to each of the addresses specified by the address specification unit, and to transmit the image data to each of the addresses.

An image processor according to a second aspect of the present invention is the image processor of the first aspect, wherein the image data having an image quality appropriate for the protocol corresponding to the address are image data with a low image quality when the protocol corresponding to the address is a FAX or InternetFAX, and the image data are image data with a high image quality when the protocol corresponding to the address is E-mail, SMB, or FTP.

According to this invention, when simultaneously transmitting an image to addresses having a plurality of protocols, it is possible to transmit the image with an image quality that is appropriate for the protocols.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a view of a frame format showing a communication system of a multifunction device in accordance with a preferred embodiment of the present invention;

FIG. 2 is a view of a block diagram showing the electrical configuration of the main portions of a multifunction device;

FIG. 3 is a plan view showing the appearance of an operating portion of the multifunction device 1;

FIG. 4 is a view of a frame format showing an example of a transmission function screen of the operation portion;

FIG. 5 is a view of a flow chart showing a transmission procedure via the multifunction device when a Start key is pressed down after an address is specified on the transmission function screen; and

FIG. 6 is view of a block diagram showing the configuration of a CPU of the multifunction device.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents. Below, an embodiment in which the present invention is applied to a multifunction device (image processor) 1 will be described referring to the figures.

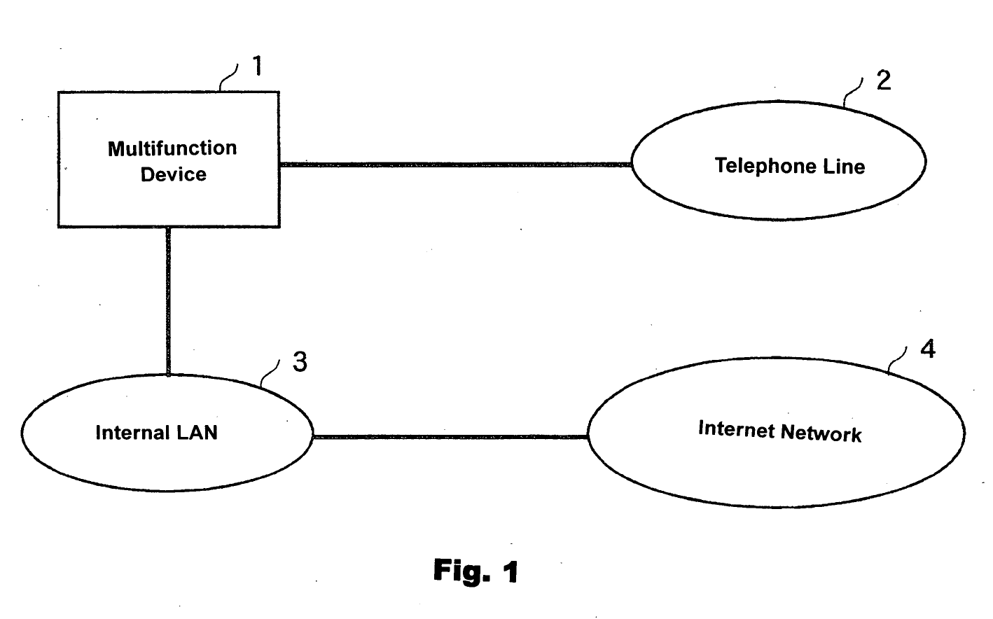

FIG. 1 shows a communication system having the multifunction device 1. The multifunction device 1 has a scanner function, a copying function, a printer function, and a communication function via a plurality of protocols. In the multifunction device 1, it is possible to perform FAX transmission, E-mail transmission, SMB (Server Message Block) transmission, FTP (File Transfer Protocol) transmission, and InternetFAX transmission.

The multifunction device 1 is connected to a telephone line 2 to allow FAX transmission. In addition, the multifunction device 1 is connected to an Internet network 4 via an internal LAN 3, to allow E-mail transmission, SMB transmission, FTP transmission, and InternetFAX transmission.

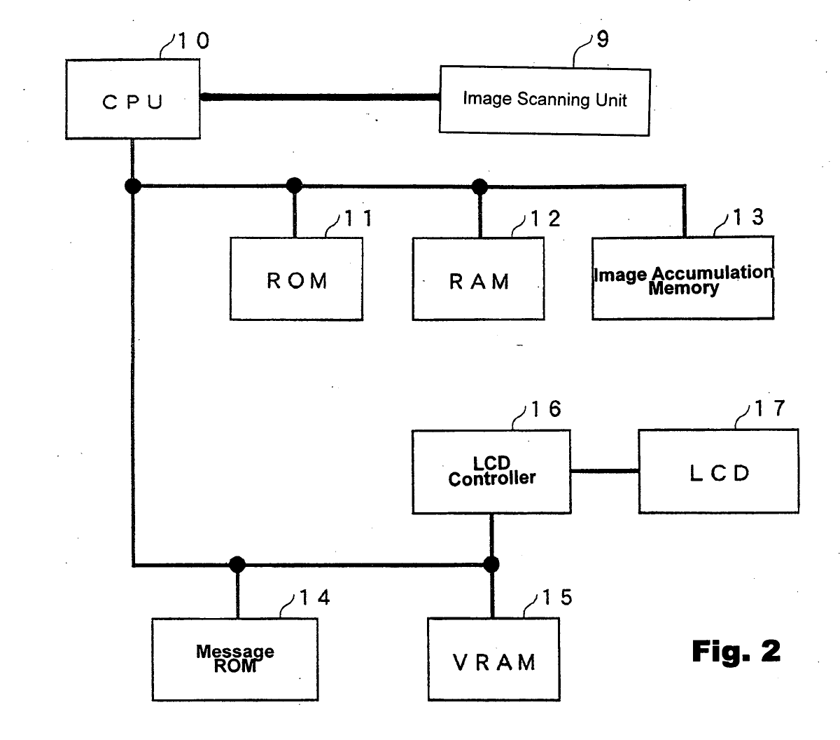

FIG. 2 shows an electrical configuration of the main portions of the multifunction device 1.

The multifunction device 1 has a CPU 10. The CPU 10, a ROM 11 that stores programs and the like thereof, a RAM 12 that stores necessary data, and an image accumulation memory 13 that stores image data are connected via a bus. In addition, a message ROM 14, VRAM 15, and LCD controller 16 are connected via a bus to the CPU 10. An LCD 17 is connected to the LCD controller 16. Further, the CPU 10 is connect to an image scanning unit 9.

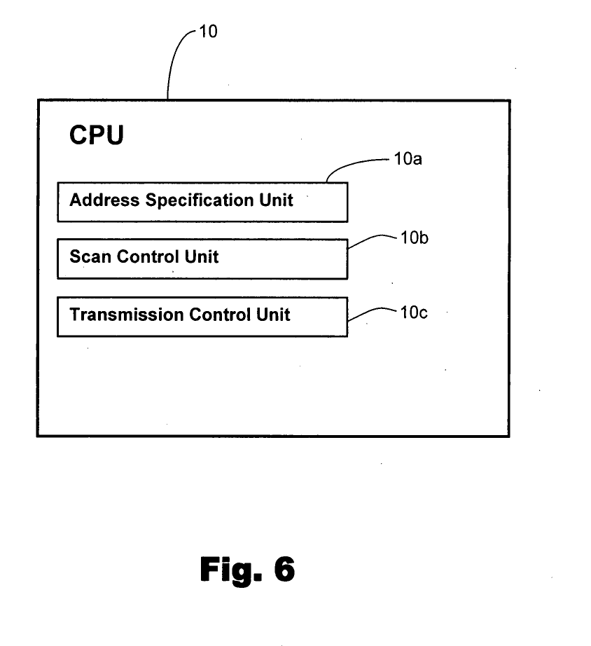

FIG. 6 shows the configuration of the CPU 10. The CPU includes an address specification unit 10a, a scan control unit 10b, and a transmission control unit 10c. The address specification unit 10a is configured to specify a plurality of addresses having different protocols as a multi-address destination. The scan control unit 10b is configured to control image data scanned by the image scanning unit 9 to be saved in the image accumulation memory 13, when a transmission start command is inputted after an address is specified by the address specification unit 10a, and an original image is scanned by the image scanning unit 9. The transmission control unit 10c is configured to generate image data stored in the image accumulation memory 13, such that the data have an image quality that is appropriate for the protocol corresponding to each of the addresses specified by the address specification unit. Further, the transmission control unit 10c transmits the appropriate data to each of the addresses.

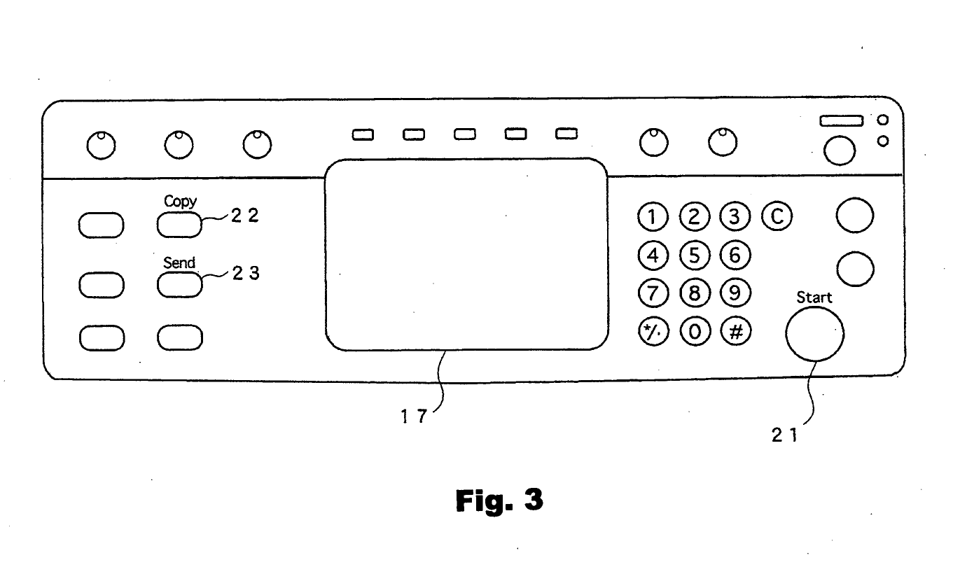

FIG. 3 shows the appearance of an operating portion of the multifunction device 1.

The LCD 17 and a plurality of keys other than the numerical keypad are arranged in the operating portion of the multifunction device 1. The plurality of keys include a Start key 21, a Copy key 22 to select the copying function, and a Send key 23 to execute the communication function via the plurality of protocols.

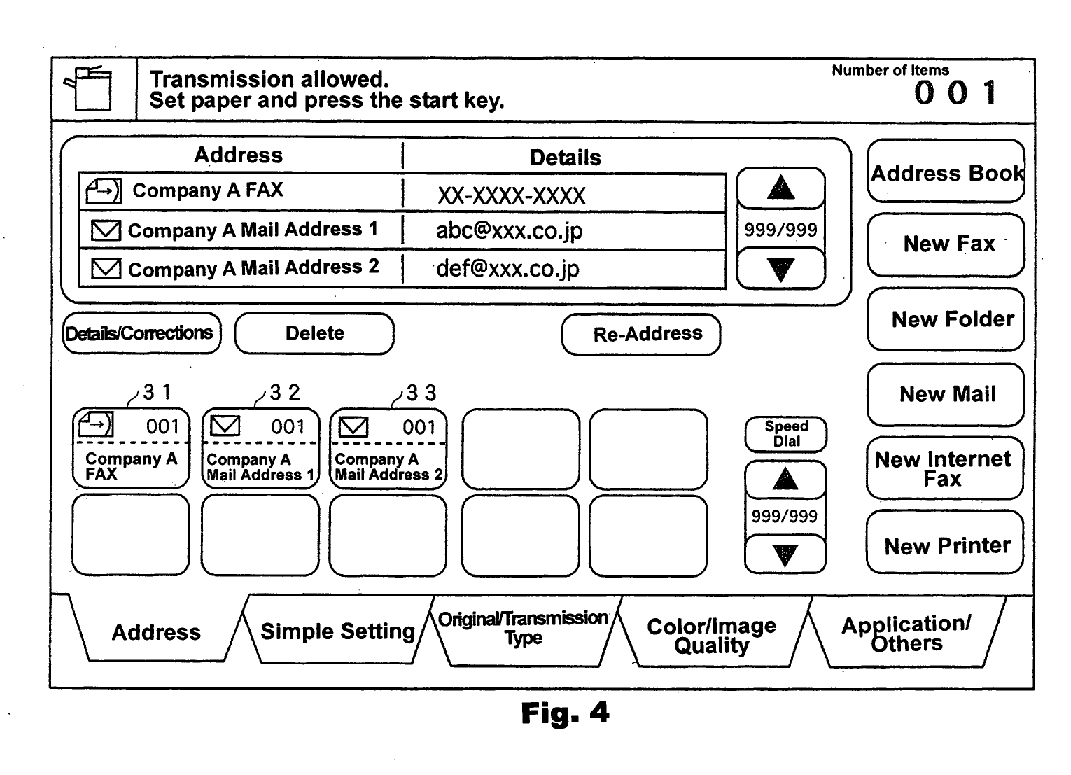

FIG. 4 shows a transmission function screen.

By pressing the Send key 23, the transmission function screen is shown on the LCD 17. When sending an original, a user sets the original on the multifunction device (document scanning device) 1, and then specifies the destination (address) on the transmission function screen via the address specification unit 10a. Then, the Start key 21 is depressed. By doing so, an original image is scanned by the image scanning unit 9, and the image is sent to the address specified by the user via the address specification unit 10a.

On the transmission function screen, addresses having a plurality of protocols (FAX, E-mail, SMB, FTP, InternetFAX) can be specified by the address specification unit 10a. An address can be specified by direct input, selecting from the address book, holding down a One touch key, and the like. In addition, SMB and FTP addresses are information that specify IP addresses and folders of the destination PCs.

In the example in FIG. 4, by pressing down One touch keys 31, 32, and 33, three addresses are specified. Basically, by pressing down the One touch key 31, the facsimile number of Company A registered in key 31 will be specified as an address. By pressing down the One touch key 32, a first mail address of Company A registered in key 32 will be specified as an address. By pressing down the One touch key 33, a second mail address of Company A registered in key 33 will be specified as an address.

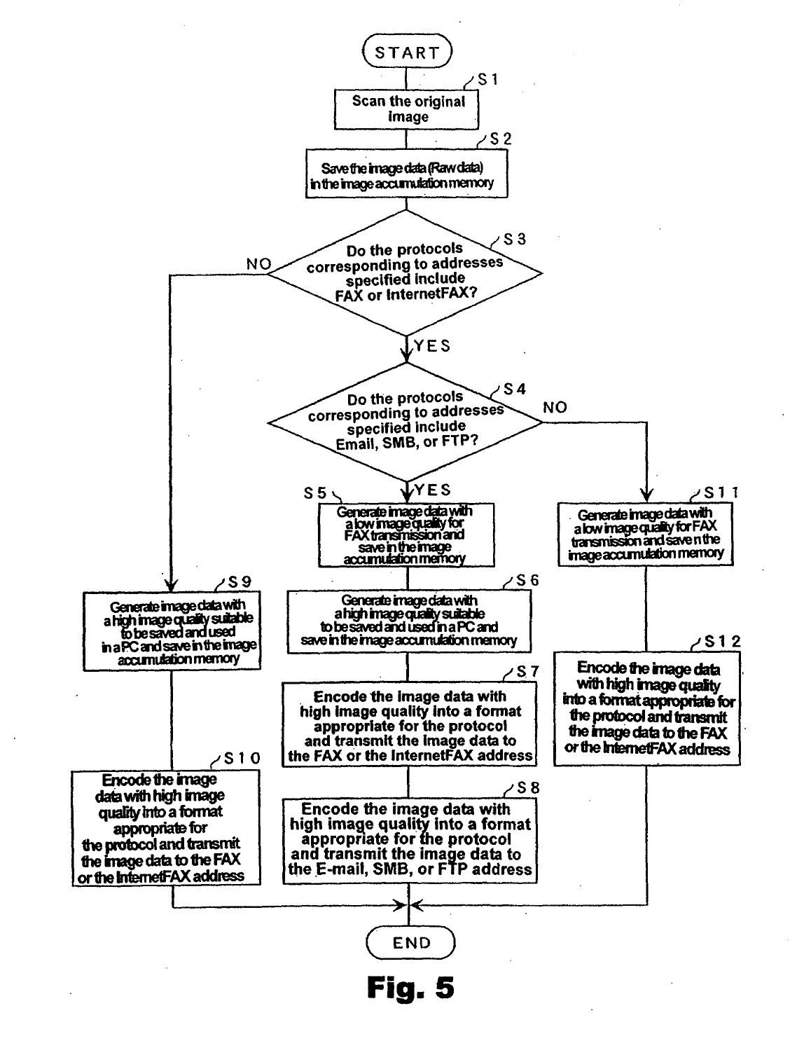

FIG. 5 shows a transmission procedure via the multifunction device 1, when the Start key 21 is pressed down after an address is specified on the transmission function screen.

When the Start key 21 is pressed down after an address is specified on the transmission function screen, the CPU 10 will start the scanning process of the original image via the image scanning unit 9 (Step S1). Next, the scan control unit 10b of the CPU 10 will convert the image data scanned by the document scanning device into digital image data (Raw data: data that are closest to the output from the input sensor), and save the data in the image accumulation memory 13 (Step S2).

Next, it is determined by the CPU 10 whether FAX or InternetFAX is included in the protocols corresponding to addresses specified on the transmission function screen (Step S3). When FAX or InternetFAX is included in the protocols corresponding to addresses specified on the transmission function screen, it is determined by the CPU 10 whether E-mail, SMB, or FTP is included in the protocols corresponding to the addresses specified on the transmission function screen (Step S4).

In the above Step S4, when it is determined that E-mail, SMB, or FTP is included in the protocols corresponding to the addresses specified on the transmission function screen, low image quality image data are generated by the scan control unit 10b for FAX transmission based on the Raw data stored in the image accumulation memory 13 and saved in the image accumulation memory 13 (Step S5). Further, at the same time, high quality image data are generated scan control unit 10b that are suitable to be saved and used in a PC based on the Raw data saved in the image accumulation memory 13 and saved in the image accumulation memory 13 (Step S6). A combination of low image quality image data and high image quality image data include, for example, a combination of simple binarization data (low image quality) and binary data (high quality) obtained by error diffusion processing, a combination of simple binarization data (low image quality) and multivalued data (high quality), and the like. In addition, image data with low image quality and low resolution can be used as a low quality image data, and image data with high quality and high resolution can be used as a high quality image data.

Furthermore, with respect to a FAX or an InternetFAX address, coded data, which are obtained after encoding the low image quality image data generated during the above Step S5 into a format corresponding to the protocol thereof, are sent by the transmission control unit 10c (Step S7). In addition, with respect to an E-mail, an SMB, or an FTP address, coded data, which are obtained after encoding the high image quality image data generated during the above Step S6 into a format corresponding to the protocol thereof, are sent (Step S8).

In the above Step S3, in the case that it is determined that FAX or InternetFAX is not included in the protocols corresponding to addresses specified on the transmission function screen, high image quality image data are generated by the scan control unit 10b that are suitable to be saved and used in a PC based on the Raw data saved in the image accumulation memory 13 and saved in the image accumulation memory 13 (Step S9). Then, with respect to an E-mail, an SMB, or an FTP address, coded data, which are obtained after encoding the high image quality image data generated during the above Step S9 into a format corresponding to the protocol thereof, are sent by the transmission control unit 10c (Step S10).

In the above Step S4, in the case that it is determined that E-mail, SMB, or FTP is not included in the protocols corresponding to the addresses specified on the transmission function screen, low image quality image data are generated by the scan control unit 10b for FAX transmission based on the Raw data saved in the image accumulation memory 13 and saved in the image accumulation memory 13 (Step S11). Then, with respect to a FAX or an InternetFAX address, coded data, which are obtained after encoding the low image quality image data generated during the above Step S11 into a format corresponding to the protocol thereof, are sent by the transmission control unit 10c (Step S12).

According to the above embodiment, in a FAX and an InternetFAX transmission, a low image quality image can be transmitted, and in an E-mail, SMB, or FTP transmission, a high image quality image can be transmitted. It becomes possible to transmit an image with an image quality that suits the protocol.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member,” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a multifunction device equipped with the present invention. Accordingly, these terms, as utilized to describe the present invention should be interpreted relative to a multifunction device equipped with the present invention as normally used. Finally, terms of degree such as “substantially,” “about,” and “approximately” as used herein mean a reasonable amount of deviation of the modified term such that the end result is not significantly changed. For example, these terms can be construed as including a deviation of at least +5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An image processor comprising:
an image scanning unit being configured to scan an original image;
memory being configured to store image data scanned by the image scanning unit;
an address specification unit being configured to specify a plurality of addresses having different protocols as a multi-address destination;
a scan control unit being configured to control the image data scanned by the image scanning unit to be saved in the memory upon input of a transmission start command after specifying an address the address specification unit and an original image being scanned by the image scanning unit; and
a transmission control unit being configured to generate transmission image data from the image data stored in the memory, the transmission image data having an image quality appropriate for the protocol corresponding to each of the addresses specified by the address specification unit, and to transmit the transmission image data to each of the addresses.

2. The image processor according to claim 1, wherein the transmission image data having an image quality appropriate for the protocol corresponding to the address are image data with a low image quality when the protocol corresponding to the address is FAX or InternetFAX, and the image data are image data with a high image quality when the protocol corresponding to the address is E-mail, SMB, or FTP.

3. A communication system, comprising:
a telephone line being configured to transmit facsimile transmissions;
an Internet network; and
a multifunction device being connected to the telephone line and Internet network, the multifunction device having
an image scanning unit being configured to scan an original image,
memory being configured to store image data scanned by the image scanning unit,
an address specification unit being configured to specify a plurality of addresses having different protocols as a multi-address destination,
a scan control unit being configured to control the image data scanned by the image scanning unit to be saved in the memory upon input of a transmission start command after specifying an address the address specification unit and an original image being scanned by the image scanning unit, and
a transmission control unit being configured to generate transmission image data from the image data stored in the memory, the transmission image data having an image quality appropriate for the protocol corresponding to each of the addresses specified by the address specification unit, and to transmit the transmission image data to each of the addresses.

4. The communication system according to claim 3, wherein the transmission image data having an image quality appropriate for the protocol corresponding to the address are image data with a low image quality when the protocol corresponding to the address is FAX or InternetFAX, and the image data are image data with a high image quality when the protocol corresponding to the address is E-mail, SMB, or FTP.
